(19) United States
(12) Patent Application Publication
(10) Pub. No.: US 2023/0201724 A1
(43) Pub. Date: Jun. 29, 2023

(54) Playground Activity Measures

(71) Applicant: Biba Ventures Inc., Vancouver (CA)

(72) Inventors: Nis Bojin, Vancouver (CA); George Dallas, Vancouver (CA); Matthew Herbert Toner, Vancouver (CA)

(21) Appl. No.: 18/145,376

(22) Filed: Dec. 22, 2022

Related U.S. Application Data
(60) Provisional application No. 63/293,434, filed on Dec. 23, 2021.

(51) Int. Cl. A63F 13/65; A63F 13/216; A63F 13/79

(52) U.S. Cl. CPC A63F 13/65; A63F 13/216; A63F 13/79; A63F 2300/535

(57) ABSTRACT

A system and method of this disclosure allows tagging a real world object (a playground) to virtual gameplay data. Therefore, an anatomy of the activities happening at each playground can be obtained, using a measurement system that is oriented around the playground. In embodiments, playground events are amalgamated into sessions, the location of the session being a centroid of the individual event locations. A collection of sessions for each playground is stored in a database. Where the session location is within a predetermined radius of a playground location, the session is assigned to the playground. This allows for reports to be generated that provide insights for a given playground such as but not limited to equipment utilization, popular times of day, popular days of the week, weather trends, popular pieces of equipment, and exercise profiles.

### CROSS REFERENCE TO CO-PENDING APPLICATIONS

This application claims priority to, and the benefit of, U.S. application Ser. No. 63/293,434 filed Dec. 23, 2021.

### BACKGROUND

This disclosure is in the field a playgrounds and, more specifically, “smart playgrounds” that combine physical play activities with virtual play activities designed to work with one or more physical play structures of the playground to produce geo-specific play data. This disclosure relates to the process which connects playground game data to physical play structures in order to be able to determine the play activity at smart playgrounds.

Part of what constitutes a smart playground is an ability to measure the activity happening at that playground through geo-located gameplay data. This allows an administrator to collect, store, tabulate and process data on a playground-by-playground basis rather than, say, a more typical user-by-user basis. This disclosure relates to the process by which a ‘game session’ is associated with location data (one or more playthroughs of one or more of playground software games) to the playground locations stored in a database.

### SUMMARY

This disclosure describes embodiments of a system and method for use in generating activity data associated with one or more playgrounds, each of the one or more playgrounds containing one or more physical play structures containing a computer-readable identification tag. Activity data may come from playground game software such as, but not limited to, BIBA™ playground game software. The game software typically runs as an app on a mobile device of a user when playing on the smart playground.

In embodiments of a system and method of this disclosure, smart playground performance metrics like playground equipment utilization, as well as playground utilization, can be obtained. For the purposes of this disclosure, a smart playground contains one or more physical play structures containing a computer-readable identification tag. One or more users, when visiting the one or more smart playgrounds, have a mobile device executing playground game software. The mobile device reads the computer-readable identification tag of a corresponding one of the one or more playground structures and passes tag information to the playground game software. An example of a smart playground is a BIBA™ smart playground.

For each mobile device running the playground game software, the playground game software tracks playground variables including location, duration and use of the one or more physical play structures, and at least one weather condition. The playground game software, through the mobile device, sends the playground variables over a network to at least one playground database including associated computer means. The at least one playground database receives and stores the playground variables and associates the playground variables with a corresponding location of the playground.

In embodiments, the method is executed by a computer and associated software (a processor and non-transitory machine readable storage medium containing instructions stored thereon), the computer being in network communication with the at least one playground database. The playground database stores variables associated with the playgrounds including gameplay data from playground game software.

In embodiments, non-transitory machine readable storage medium contains instructions stored thereon that, when executed by a computer:
store a location of one or more playgrounds in at least one database, each playground including one or more playground structures including a computer readable identification tag readable by a mobile device when running a playground game software;
collect from the mobile device, within a time window of a series of predetermined rolling time windows, (i) game play events as tracked by the playground game software and (ii) game play event locations;
store the game play events and game play locations on the mobile device or in the at least one database;
wherein, for each mobile device, if no game play event is received within a next time window of the series of predetermined rolling time windows, the instructions
   combine all game play events collected in all previous time windows of the series into a game play session; and
   store the game play session in the at least one database;
wherein for each game play session, the instructions
   calculate a centroid of the game play event locations;
   store the centroid as a location of the game play session; and
   assign the game play session to a corresponding one of stored playground locations if the centroid falls within a predetermined distance from the corresponding one of the stored playground locations; and
wherein, for each of the stored playground locations, the instructions
   combine all the game play sessions assigned to the corresponding one of the stored playground locations;
   analyze, using one or more machine learning algorithms, the combined game play sessions to determine playground activity at the corresponding one of the stored playground locations; and
   report the playground activity to an end user, the report including utilization of the one or more playground structures.

### BRIEF DESCRIPTION OF THE DRAWINGS

FIG. 1 is a process flow for a prior art smart playground.

FIG. 2 is a prior art smart playground system and method, including collecting and storing data on smart playground activity. Although two mobile devices are shown, a user and a caregiver mobile device, a single mobile device may be used.

FIG. 3 is a schematic illustrating a system and method of this disclosure which calculates a session location as a centroid of event points.

FIG. 4 is a schematic illustrating the system and method defining a catchment area to assign sessions to a specific playground. The catchment area may be defined by a preterminal radius from a playground location (latitude and longitude) or by predetermined distances.

### DETAILED DESCRIPTION

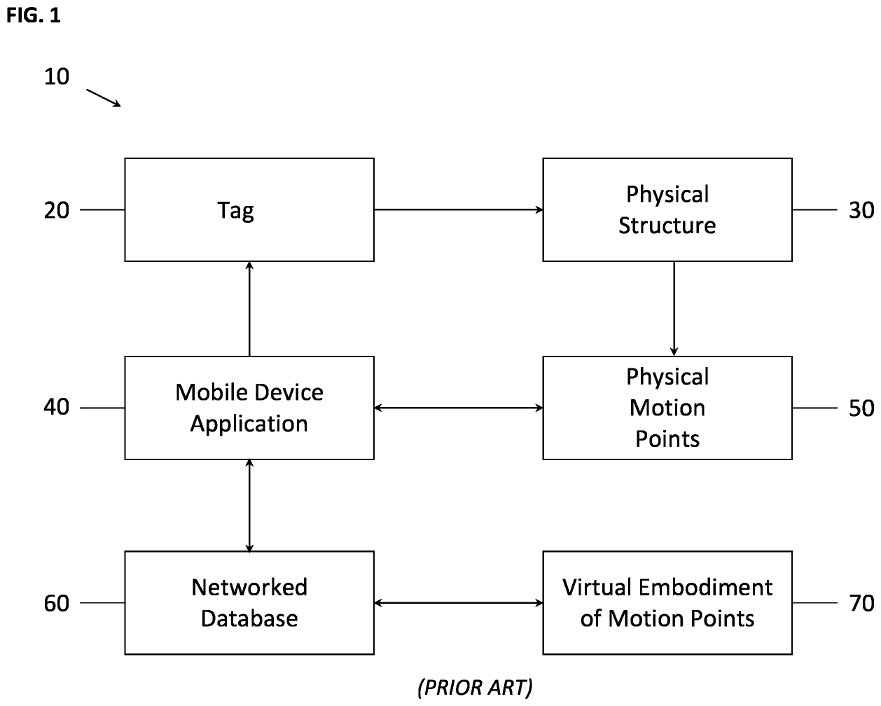

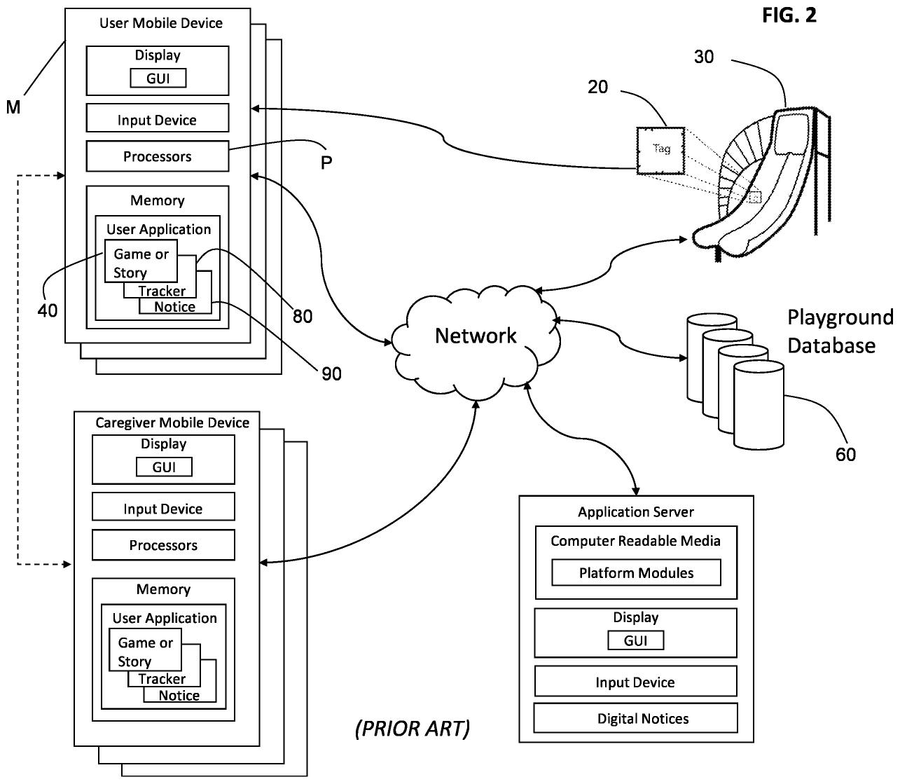

Referring now to FIGS. 1 and 2, the one or more playgrounds may contain one or more physical play structures 30 containing a computer-readable identification tag 20. One or more users, when visiting the one or more playgrounds, may have a mobile device M executing the playground game software 40. The mobile device M reads the computer-readable identification tag 20 of a corresponding one of the one or more playground structures 30 and passes tag information to the playground game software 40. For each mobile device M running the playground game software, the playground game 40 software tracks playground variables including location, duration and use of the one or more physical play structures 30, and at least one weather condition. The playground game software 40, through the mobile device M, sends the playground variables over a network to the at least one playground database 60. The at least one playground database 60 receives and stores the playground variables and associates the playground variables with a corresponding location of the playground.

The smart playground 10 includes at least one physical play structure 30 containing a computer-readable identification tag 20 and a virtual game, app or story 40 running on a mobile device M designed to work with the at least one physical play structure 30. The mobile device application 40 is in network communication with a database 60. An example of this type of playground is disclosed in U.S. Pat. No. 9,314,694 B2 to Nadel et al., the content of which is incorporated by reference herein. Other examples include playgrounds using BIBA™ mobile games marketed by PlayPower, Inc. and Biba Ventures, Inc.

As a user plays on or interacts with the physical play structure 30 physical motion points 50 are obtained and translated into a virtual embodiment of motion points 70. However, unlike other play experiences, the virtual motion points 70 are not identical to those of the physical motion points 50 because the physical play being experienced on the play structure 30 is not the same as the virtual play being executed by the mobile device application 40. The play of the mobile device application 40 is not intended to replicate the same play but rather motivate the user to play on or continue to play on the play structure 30. Physical play translates to user progress through the virtual game, app, or story.

A play tracker 80 tracks physical motion points 50 and virtual game progress 40_{P} when a predetermined milestone 40_{M} is accomplished in the virtual game 40, a digital notice 90_{N} may be sent to the user's mobile device or the user's care giver's mobile device. For a community-integrated smart playground—such as that disclosed in U.S. Pat. No. 10,953,333 B2 to Rosen et al., the content of which is incorporated by reference herein—other criterion, such as but not limited to physical presence on the playground or demographic data of the user or caregiver, may be used to issue a digital notice 90_{N}. The notice 90_{N} may include a benefit or reward offered by third party located within a predetermined radius of the playground or play structure 30. Redemption of the benefit or reward may be tracked. Some portion of the revenue connected with displaying the notice 90_{N} or redeeming the benefit may be allocated to the playground or between a curator of the notice 90_{N} and the playground. In this way, the playground provides its own revenue stream for maintenance and improvements. The geo-specific play data 80_{D} collected may also be provided to playground owners and operators for use in managing the playground and its utilization.

The physical play structure 30 may be a piece of playground equipment such as balancing equipment, climbing equipment, jumping equipment, riding equipment, sliding equipment, spinning equipment, or swinging equipment. The identification tag 20 may be a quick response code, an augmented reality card, a radio-frequency identification tag, or a near field identification tag. Movement of a user on the physical play structure 30 may be detected using an accelerometer or a global positioning system and may be translated into movement or progress within the virtual game or story 40. The virtual game, app or story 40 may be a mobile software app, with the user's mobile device M being used to track physical movement. The virtual game or story 40 represents a play activity different than the one being played on the play structure 30.

As user movement is tracked, detailed geo-specific play data 80_{D} may be collected and transformed into reports and insights that can help playground owners and operators make better choices and smarter funding decisions. Embodiments of this disclosure may be configured to collect data ranging from peak play hours to factors such as but not limited to weather and user demographics. Other data may include caregiver demographics, play pattern data relative to equipment, and chronological data.

When users play a virtual game like BIBA™ playground games, geo-specific play data can be collected, including the coordinates where game events occurred, the time they occurred, what game was played, how long it was played , what phone model was used. Gameplay data may also be collected that is specifically tailored around the playground experience. This data includes exercise information, equipment preference information, survey results from questions about the playground and weather information. The virtual game may be non-analogous to the physical play but game progress is determined by the physical play. The system and method of its use may be executed by at least one mobile device having at least one microprocessor in network communication with the computer-readable identification tag and including associated software. The game is typically executed as an app.

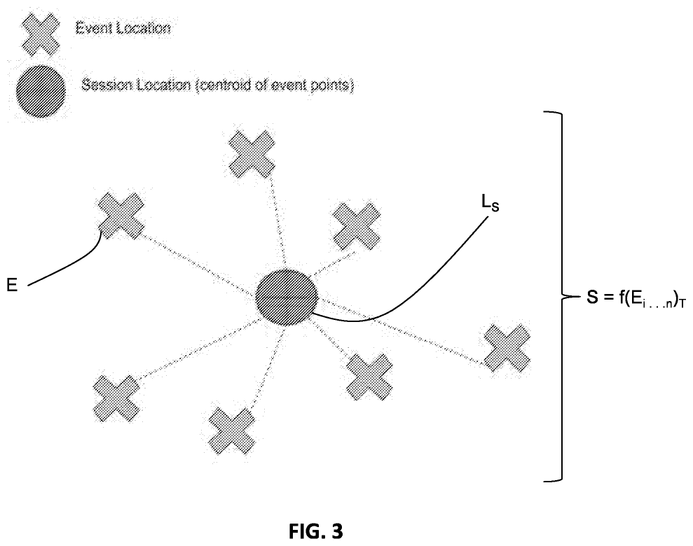

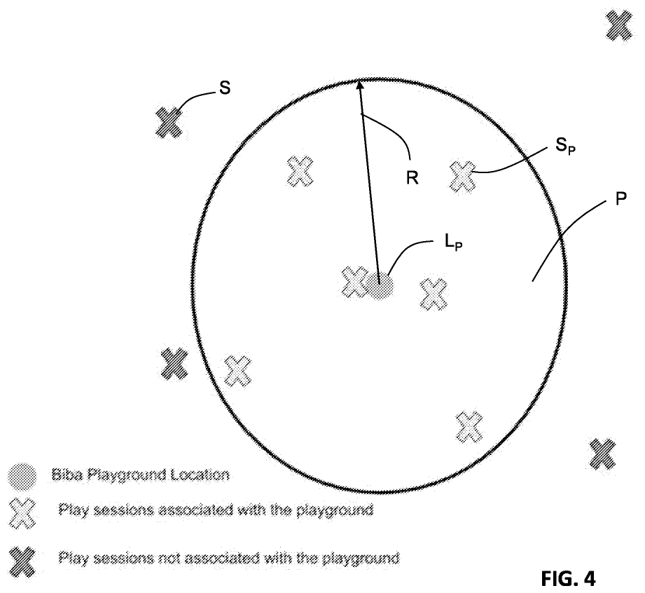

Referring to FIGS. 3 and 4, in embodiments the gameplay events E that one user generates between opening the app and not sending an event for at least a predetermined time interval is called a session S. By way of an example, the predetermined time interval T may be five minutes and, therefore, a five-minute rolling window is used for gameplay events E from each user. In this example, if the user doesn't send an event E for five minutes, the previous events E are amalgamated into a session S. Other predetermined. time intervals T may be used, Sessions S are stored in a database and include all the information collected while a user was playing the app. The location L_{S} of a session S is logged as the centroid of the event F locations collected within the session S. See FIG. 3.

Therefore even though multiple events E with multiple latitudes and longitudes are used to collect the information in a session S, a session S has just 1 latitude and 1 longitude, as defined by the events E. A table used to create playground sessions S comes from a session table. Each session S is one row of the table, with location information L_{S} as well as collected event information such as, but not limited to time, equipment preference, and survey results.

As previously described, a playground P includes at least one physical play structure 30 containing a computer-readable identification tag 20, the at least one physical play structure 30 representing a physical play activity. Playground locations L_{P} may be collected using the tags 20 such as BIBA™ tags (e.g., a signpost on the playground prompting visitors to play BIBA™ games. as well small square tags, which are physical devices placed on different pieces of equipment).

Playground locations L_{P} may also be collected by smart playground customers where the playgrounds are located during a sales process. Playgrounds P may also be located through user feedback in the app. The playground locations L_{P} are stored in a database, the database being in network communication with at least one microprocessor. The result of collecting playground locations L_{P} is a table in the database with playground name, address, coordinates and, optionally, contact information and sales information.

The method by which gameplay sessions S can be associated to specific playgrounds P, thus creating playground sessions S_{P}, is by gathering all the sessions S that occur within a certain predetermined radius R of each playground location L_{P}. See FIG. 4. If the distance between the location L_{S} of the session S (as defined by the centroid of the totality of events E within the session S) and the location L_{P} of a playground P is less than the predetermined radius R, the session S is allocated to that playground P. If the distance is greater than radius R, it is not. For sessions S that are within the predetermined radius R for more than one playground P, the session S is allocated to the playground P that is closest to the session's location S_{L}.

This novel process allows tagging a real world object (a playground) to virtual gameplay data. Therefore, an anatomy of the activities happening at each playground can be obtained, using a measurement system that is oriented around the playground. This results in being able to analyze data on a playground by playground basis, and is a fundamental building block in machine learning processes.

Once this process is completed, there is a collection of sessions for each playground, which is stored in a database. This allows for reports to be generated that provide insights for a given playground such as but not limited to equipment utilization, popular times of day, popular days of the week, weather trends, popular pieces of equipment, and exercise profiles.

What is claimed:

1. Non-transitory machine readable storage medium containing instructions stored thereon, the instructions when executed by a processor:
store a location of one or more playgrounds in at least one database, each playground including one or more playground structures including a computer readable identification tag readable by a mobile device when running a playground game software;
collect from the mobile device, within a time window of a series of predetermined rolling time windows, (i) game play events as tracked by the playground game software and (ii) game play event locations;
store the game play events and game play locations in the at least one database;
wherein, for each mobile device, if no game play event is received within a next time window of the series of predetermined rolling time windows, the instructions
combine all game play events collected in all previous time windows of the series into a game play session; and
store the game play session in the at least one database;
wherein for each game play session, the instructions
calculate a centroid of the game play event locations;
store the centroid as a location of the game play session; and
assign the game play session to a corresponding one of stored playground locations if the centroid falls within a predetermined distance from the corresponding one of the stored playground locations; and
wherein, for each of the stored playground locations, the instructions
combine all the game play sessions assigned to the corresponding one of the stored playground locations;
analyze, using one or more machine learning algorithms, the combined game play sessions to determine playground activity at the corresponding one of the stored playground locations; and
report the playground activity to an end user, the report including utilization of the one or more playground structures.

2. A system for generating activity data associated with one or more playgrounds, the system comprising;
at least one database in network communication with a playground game software executable on a mobile device; and
non-transitory machine readable medium containing instructions stored thereon, the instructions when executed by a processor:
store a location of one or more playgrounds in the at least one database, each playground including one or more playground structures including a computer readable identification tag readable by a mobile device when running a playground game software;
collect from the mobile device, within a time window of a series of predetermined rolling time windows, (i) game play events as tracked by the playground game software and (ii) game play event locations;
store the game play events and game play locations on the mobile device or in the at least one database;
wherein, for each mobile device, if no game play event is received within a next time window of the series of predetermined rolling time windows, the instructions
combine all game play events collected in all previous time windows of the series into a game play session; and
store the game play session in the at least one database;
wherein for each game play session, the instructions
calculate a centroid of the game play event locations;
store the centroid as a location of the game play session; and
assign the game play session to a corresponding one of stored playground locations if the centroid falls within a predetermined distance from the corresponding one of the stored playground locations; and
wherein, for each of the stored playground locations, the instructions
combine all the game play sessions assigned to the corresponding one of the stored playground locations;
analyze, using one or more machine learning algorithms, the combined game play sessions to determine playground activity at the corresponding one of the stored playground locations; and
report the playground activity to an end user, the report including utilization of the one or more playground structures.

3. A method for generating activity data associated with one or more playgrounds, the method being executed by a computer and associated software, the method comprising:
storing a location of each playground of the one or more playgrounds in at least one database;
collecting, from one or more mobile devices running playground game software and within each time window of a series of predetermined rolling time windows, (i) game play events as tracked by the playground game software and (ii) game play event locations;
storing the game play events and game play locations in the at least one database;
wherein, for each mobile device, if no game play event is received within a next time window of the series, combining all game play events collected in all previous time windows of the series into a game play session; and
storing the game play session in the at least one database;
wherein for each game play session:
calculating a centroid of the game play event locations;
storing the centroid as a location of the game play session; and
assigning the game play session to a corresponding one of the stored playground locations if the centroid falls within a predetermined distance from the corresponding one of the stored playground locations; and
wherein, for each of the stored playground locations:
combining all the game play sessions assigned to the corresponding one of the stored playground locations;
analyzing, using one or more machine learning algorithms, the combined game play sessions to determine playground activity at the corresponding one of the stored playground locations; and
reporting the playground activity to an end user, the reporting including utilization of the one or more playground structures.
